(19) United States
(12) Patent Application Publication
(10) Pub. No.: US 2026/0088476 A1
(43) Pub. Date: Mar. 26, 2026

(54) SECONDARY BATTERY

(71) Applicant: Samsung SDI CO, Ltd., Yongin-si (KR)

(72) Inventors: Juyoung Lee, Yongin-si (KR); Seonju Choi, Yongin-si (KR)

(73) Assignee: Samsung SDI Co, Ltd,, Yongin-si (KR)

(21) Appl. No.: 19/267,179

(22) Filed: Jul. 11, 2025

(30) Foreign Application Priority Data
Sep. 24, 2024 (KR) 10-2024-0129291

(51) Int. Cl. H01M 50/682; H01M 50/103; H01M 50/548; H01M 50/636

(52) U.S. Cl. CPC H01M 50/682; H01M 50/103; H01M 50/548; H01M 50/636

(57) ABSTRACT

A secondary battery is provided. The secondary battery includes an electrode assembly including a first electrode, a separator, and a second electrode, a case configured to accommodate the electrode assembly, and an electrolyte supply pack positioned in a space between the electrode assembly and an inner surface of the case and configured to supply a supplementary electrolyte into the case when internal pressure of the case reaches a predetermined pressure.

### CROSS-REFERENCE TO RELATED APPLICATIONS

This present application claims priority to and the benefit under 35 U.S.C § 119(a)-(d) of Korean Patent Application No.10-2024-0129291, filed on Sep. 24, 2024, in the Korean Intellectual Property Office, the entire disclosure of which is incorporated herein by reference.

### FIELD

The present disclosure relates to a secondary battery.

### BACKGROUND

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

To solve the problems described herein, aspects of embodiments of the present disclosure provide a secondary battery including an electrolyte supply pack.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

According to embodiments of the present disclosure, a secondary battery includes an electrode assembly including a first electrode, a separator, and a second electrode, a case configured to accommodate the electrode assembly, and an electrolyte supply pack positioned in a space between the electrode assembly and an inner surface of the case and configured to supply a supplementary electrolyte into the case when internal pressure of the case reaches a predetermined pressure.

According to some embodiments, a first electrode terminal electrically connected to a first lead tab of the first electrode may be formed on a first side surface of the case, and the electrolyte supply pack may be positioned adjacent to the first lead tab of the first electrode inside the case.

According to some embodiments, the electrolyte supply pack may include one or more first supply packs configured to supply a first supplementary electrolyte when the internal pressure of the case reaches a first pressure, and one or more second supply packs configured to supply a second supplementary electrolyte when the internal pressure of the case reaches a second pressure that is different from the first pressure.

According to some embodiments, the first pressure may be ½ and the second pressure may be ⅔ with respect to a pressure at which a vent portion formed in the case is opened.

According to some embodiments, a first electrode terminal electrically connected to a first lead tab of the first electrode may be formed on a first side surface of the case, and one first supply pack among the one or more first supply packs may be positioned on one side surface of the first lead tab of the first electrode in an internal space of the case, and one second supply pack among the one or more second supply packs may be positioned on another side surface of the first lead tab of the first electrode in the internal space of the case.

According to some embodiments, a second electrode terminal electrically connected to a second lead tab of the second electrode may be formed on a second side surface opposite to the first side surface of the case, and another first supply pack among the one or more first supply packs may be positioned on one side surface of the second lead tab of the second electrode in the internal space of the case, and another second supply pack among the one or more second supply packs may be positioned on another side surface of the second lead tab of the second electrode in the internal space of the case.

According to some embodiments, the one or more first supply packs and the one or more second supply packs may be positioned to face each other inside the case.

According to some embodiments, the electrolyte supply pack may include a thin film that contains the supplementary electrolyte.

According to some embodiments, the thin film may include at least one of polyamide (PA), polyethylene (PE), or polypropylene (PP).

According to some embodiments, the thin film may include a rupture portion configured to be ruptured when the internal pressure of the case reaches the predetermined pressure.

According to some embodiments, the rupture portion may be positioned at a location facing the electrode assembly on the thin film.

According to some embodiments, the rupture portion may include one or more notches having a thickness less than a thickness of a periphery of the rupture portion on the thin film.

According to some embodiments, the rupture portion may include a thin film patch bonded to a periphery of a vent formed on the thin film.

According to some embodiments, a secondary battery includes an electrode assembly including a first electrode, a separator, and a second electrode, a case configured to accommodate the electrode assembly, wherein the first electrode is formed on a first side surface and electrically connected to a first lead tab of the first electrode, and the second electrode is formed on a second side surface opposite the first side surface and electrically connected to a second lead tab of the second electrode; and an electrolyte supply pack positioned on at least one side surface of the first lead tab of the first electrode or the second lead tab of the second electrode in a space between the electrode assembly and an inner surface of the case, and configured to supply a supplementary electrolyte into the case when internal pressure of the case reaches a predetermined pressure.

According to some embodiments, the electrolyte supply pack may include a thin film that contains the supplementary electrolyte.

According to some embodiments, the electrolyte supply pack may include one or more first supply packs configured to supply a first supplementary electrolyte when the internal pressure of the case reaches a first pressure, and one or more second supply packs configured to supply a second supplementary electrolyte when the internal pressure of the case reaches a second pressure that is different from the first pressure.

According to some embodiments, the second pressure may be 1.5 to 2 times the first pressure.

According to some embodiments, one first supply pack among the one or more first supply packs may be positioned on one side surface of the first lead tab of the first electrode in an internal space of the case, and one second supply pack among the one or more second supply packs may be positioned on another side surface of the first lead tab of the first electrode in the internal space of the case.

According to some embodiments, another first supply pack among the one or more first supply packs may be positioned on one side surface of the second lead tab of the second electrode in an internal space of the case, and another second supply pack among the one or more second supply packs may be positioned on another side surface of the second lead tab of the second electrode in the internal space of the case.

According to some embodiments, the one or more first supply packs and the one or more second supply packs may be positioned to face each other inside the case.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a perspective view illustrating a secondary battery according to one embodiment of the present disclosure.

FIG. 2 is a cross-sectional view showing a state in which an electrode plate of a secondary battery is in an unexpanded state according to one embodiment of the present disclosure.

FIG. 3 is a cross-sectional view showing a state in which an electrode plate of a secondary battery is in an expanded state according to one embodiment of the present disclosure.

FIGS. 4 and 5 are drawings showing that first supply packs facing each other are pre-opened and second supply packs facing each other are post-opened inside the case of the secondary battery according to one embodiment of the present disclosure.

FIGS. 6 and 7 are drawings showing that first supply packs positioned diagonally from each other inside the case of the secondary battery according to one embodiment of the present disclosure are pre-opened and second supply packs positioned diagonally from each other are post-opened.

FIG. 8 is a cross-sectional view showing a secondary battery according to one embodiment of the present disclosure.

FIG. 9 is a drawing showing an enlarged area of the peripheral portion of a 1-1 supply pack in the cross-sectional view of the secondary battery of FIG. 8.

FIG. 10 is a drawing showing a first rupture point at which a first supply pack is opened and a second rupture point at which a second supply pack is opened, according to one embodiment of the present disclosure.

FIGS. 11 to 13 are drawings showing various shapes of rupture portions R according to an embodiment of the present disclosure.

FIG. 14 is a drawing showing the discharge form of a first supplementary electrolyte according to an embodiment of the present disclosure.

FIGS. 15 to 18 are drawings showing an electrolyte supply pack including a first supplementary electrolyte according to an embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure.

Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements.

As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C,” “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed herein could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In a case where the secondary battery performs repeated charging and discharging, the electrolyte inside the secondary battery may decompose and the film may form on the surface of the electrode plate. In addition, repeated charging and discharging may lead to depletion of the electrolyte in the secondary battery due to the electrolyte depletion reaction. This may cause problems such as reduced battery capacity, increased internal resistance, slow charge/discharge rates, overheating and safety issues, voltage instability, shortened battery life, and cell imbalance. Therefore, there is a need to develop a secondary battery that is usable more stably for a long period of time by preventing rapid depletion of an electrolyte.

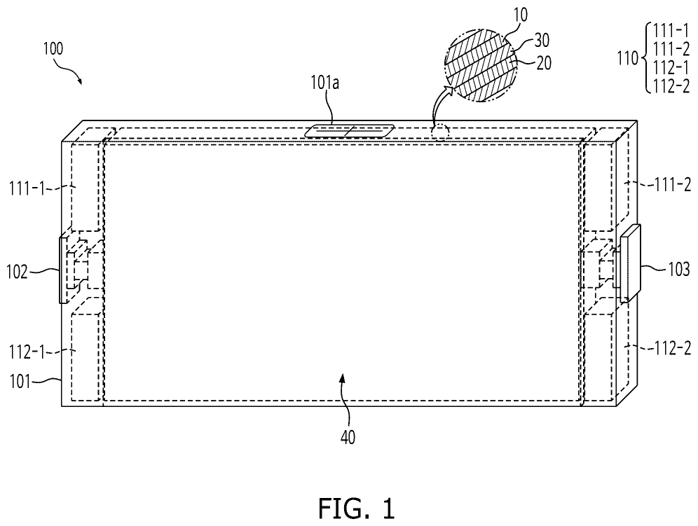

FIG. 1 illustrates a perspective view of a secondary battery 100 according to an embodiment of the present disclosure. Referring to FIG. 1, the secondary battery 100 according to an embodiment of the present disclosure may include an electrode assembly 40, a case 101, and an electrolyte supply pack 110. Specifically, the electrode assembly 40 may include a first electrode 10, a separator 20, and a second electrode 30, and the case 101 may accommodate the electrode assembly 40. One or more electrolyte supply packs 110 may be positioned in a space between the electrode assembly 40 and the inner surface of the case 101 and may be configured to supply a supplementary electrolyte into the case 101 when the internal pressure of the case 101 reaches a predetermined pressure.

A first electrode terminal 102 electrically connected to a first lead tab 104 of the first electrode 10 may be formed on a first side surface of the case 101, and the electrolyte supply pack 110 may be positioned adjacent to the first lead tab 104 of the first electrode 10 inside the case 101. In some embodiments, the electrolyte supply pack 110 may include one or more first supply packs that supply a first supplementary electrolyte when the internal pressure of the case 101 reaches a first pressure, and one or more second supply packs that supply a second supplementary electrolyte when the internal pressure of the case 101 reaches a second pressure that is different from the first pressure.

In addition, a second electrode terminal 103 electrically connected to a second lead tab 105 of the second electrode 30 may be formed on a second side surface of the case 101, and the electrolyte supply pack 110 may be positioned adjacent to the second lead tab 105 of the second electrode 30 inside the case 101. In some embodiments, the electrolyte supply pack 110 may include one or more first supply packs that supply a first supplementary electrolyte when the internal pressure of the case 101 reaches a first pressure, and one or more second supply packs that supply a second supplementary electrolyte when the internal pressure of the case 101 reaches a second pressure that is different from the first pressure.

As shown in FIG. 1, the first supply pack may include a (1-1)^{th} supply pack 111-1 positioned on one side surface of the first lead tab 104 of the first electrode 10 and a (1-2)^{th} supply pack 111-2 positioned on one side surface of the second lead tab 105 of the second electrode 30. In some embodiments, the second supply pack may include a (2-1)^{th} supply pack 112-1 positioned on the other side surface of the first lead tab 104 of the first electrode 10 and a (2-2)^{th} supply pack 112-2 positioned on the other side surface of the second lead tab 105 of the second electrode 30.

In a case where the pressure of the case 101 increases due to the swelling phenomenon of the electrode, the pressure may sequentially reach the first pressure and the second pressure. First, in a case where the internal pressure of the case 101 reaches the first pressure, the (1-1)^{th} supply pack 111-1 and the (1-2)^{th} supply pack 111-2 may be opened so that the first supplementary electrolyte may be discharged, and the discharged first supplementary electrolyte may be mixed with the electrolyte that has reacted with the electrode inside the case 101. Then, in a case where the internal pressure of the case 101 reaches the second pressure, the (2-1)^{th} supply pack 112-1 and the (2-2)^{th} supply pack 112-2 may be opened so that the second supplementary electrolyte may be discharged, and the discharged second supplementary electrolyte may be additionally mixed with the electrolyte that has reacted with the electrode inside the case 101.

As such, in a case where the internal pressure of the case 101 increases due to the expansion of the electrode plate of the secondary battery 100, the electrolyte supply pack 110 may be opened by the increased pressure, so that the unreacted supplementary electrolyte is mixed with the reacted electrolyte, thereby increasing the life of the electrolyte. In some embodiments, a plurality of the electrolyte supply packs 111-1, 111-2, 112-1, 112-2 positioned inside the secondary battery 100 may be sequentially opened according to the magnitude of the increasing pressure to supply the unreacted supplementary electrolyte, thereby supplementing the electrolyte inside the secondary battery 100 and preventing problems due to electrolyte depletion.

The electrolyte supply pack 110 may be provided in an empty space provided on the side surface of the configuration electrically connected to the electrode assembly 40 around the cap plate where the electrode terminals 102 and 103 are positioned. For example, the electrolyte supply pack 110 may be positioned in an empty space provided on the side surface or around the lead tabs 104 and 105 positioned for electrical connection between each of the first electrode terminal 102 and the second electrode terminal 103 and the first electrode 10 and the second electrode 30.

The amount of the supplementary electrolyte provided from the electrolyte supply pack 110 may be 5% to 30% of the amount of electrolyte already filled inside the case 101.

For example, the (1-1)^{th} supply pack 111-1 may supply the supplementary electrolyte corresponding to 10% of the total amount of electrolyte inside the case 101, the (1-2)^{th} supply pack 111-2 may supply the supplementary electrolyte corresponding to 10% of the total amount of electrolyte inside the case 101, the (2-1)^{th} supply pack 112-1 may supply the supplementary electrolyte corresponding to 5% of the total amount of electrolyte inside the case 101, and the (2-2)^{th} supply pack 112-2 may supply the supplementary electrolyte corresponding to 5% of the total amount of electrolyte inside the case 101. In this case, the amount of the supplementary electrolyte provided by the electrolyte supply pack 110 may be 30% of the amount of electrolyte already filled inside the case 101.

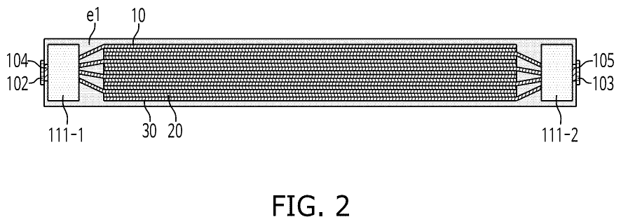

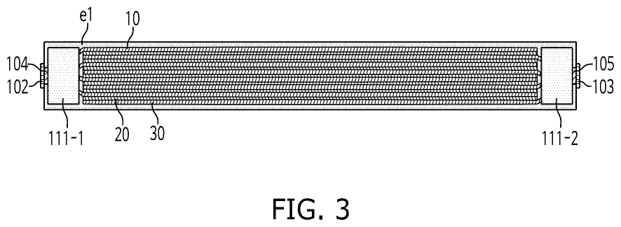

FIG. 2 illustrates a cross-sectional view showing a state in which an electrode plate of a secondary battery according to an embodiment of the present disclosure is not expanded. FIG. 3 illustrates a cross-sectional view showing a state in which an electrode plate of a secondary battery according to an embodiment of the present disclosure is expanded. Referring to FIGS. 2 and 3, an electrode assembly 40 formed by stacking a first electrode 10, a second electrode 30, and a separator 20 is positioned inside a case 101 of a secondary battery, and lead tabs 104 and 105 extending from the first electrode 10 and the second electrode 30 on opposite sides of the electrode assembly 40 may be electrically connected to a first electrode terminal 102 and a second electrode terminal 103, respectively. In some embodiments, the first supply packs 111-1 and 111-2 may be installed on the side surfaces of the lead tabs 104 and 105. As charging and discharging of the secondary battery 100 are repeated, expansion of the electrodes 10 and 20 may occur.

As shown in FIG. 3, as charging and discharging of the secondary battery 100 are repeated, the first electrode 10 and the second electrode 30 may be expanded. The expansion of the electrodes 10 and 20 may proceed in the thickness direction and/or the width direction of the electrode. The expanded electrodes 10 and 20 may increase the internal pressure of the sealed case 101.

The electrolyte is provided as an incompressible liquid. Accordingly, as the electrodes 10 and 20 positioned inside the case 101 are expanded, substantially the same pressure may be applied to all external areas of the electrolyte supply packs 111-1 and 111-2 by the electrolyte e1 filled inside the case 101. Due to the pressure, a portion of the surfaces of the electrolyte supply packs 111-1 and 111-2 may be ruptured, and thus the supplementary electrolyte contained therein may be discharged through openings on the supply packs 111-1 and 111-2 formed thereon.

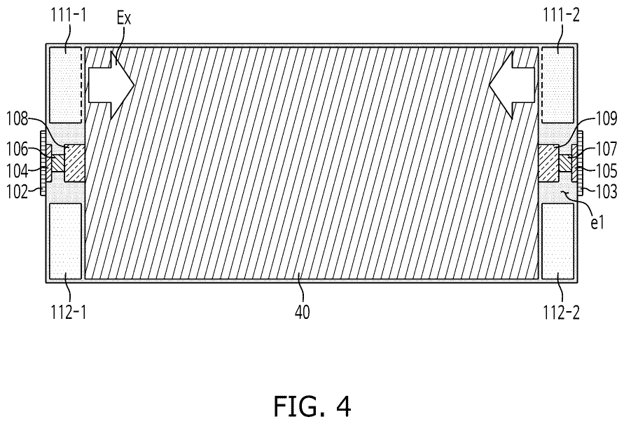

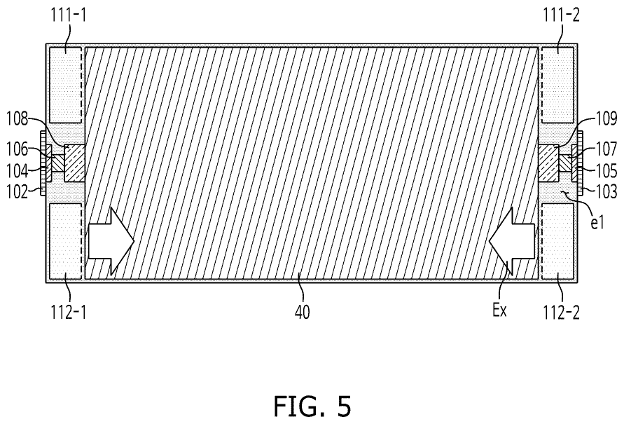

FIGS. 4 and 5 show that the first supply packs facing each other are pre-opened and the second supply packs facing each other are post-opened inside the case of the secondary battery according to an embodiment of the present disclosure. Referring to FIGS. 4 and 5, the first electrode terminal 102 electrically connected to the first lead tab 104 of the first electrode 10 may be formed on the first side surface of the case 101. In some embodiments, a plurality of electrode tabs 108 formed to protrude from the first electrode 10 may be electrically connected to the first lead tab 104 through a current collector plate 106. In some embodiments, the second electrode terminal 103 electrically connected to the second lead tab 105 of the second electrode 30 may be formed on the second side surface opposite to the first side surface of the case 101.

In some embodiments, a plurality of electrode tabs 109 formed to protrude from the second electrode 30 may be electrically connected to the second lead tab 105 through a current collector plate 107.

One first supply pack 111-1 among one or more first supply packs may be positioned on one side surface of the first lead tab 104, the current collector plate 106, and/or the electrode tab 108 of the first electrode 10 in the internal space of the case 101, and one second supply pack 112-1 among one or more second supply packs may be positioned on the other side surface of the first lead tab 104, the current collector plate 106, and/or the electrode tab 108 of the first electrode 10 in the internal space of the case 101. Similarly, another first supply pack 111-2 among one or more first supply packs may be positioned on one side surface of the second lead tab 105, the current collector plate 107, and/or the electrode tab 109 of the second electrode 30 in the internal space of the case 101, and another second supply pack 112-2 among one or more second supply packs may be positioned on the other side surface of the second lead tab 105, the current collector plate 107, and/or the electrode tab 109 of the second electrode 10 in the internal space of the case 101.

With this configuration, one or more first supply packs may be positioned to face each other with the electrode assembly 40 as the center within the case 101. In some embodiments, one or more second supply packs may be positioned to face each other with the electrode assembly 40 as the center within the case 101. For example, as shown, the (1-1)^{th} supply pack 111-1 and the (1-2)^{th} supply pack 111-2 may be disposed to face each other on opposite side surfaces within the case 101. Similarly, the (2-1)^{th} supply pack 112-1 and the (2-2)^{th} supply pack 112-2 may be disposed to face each other on opposite side surfaces within the case 101. The first supply pack and/or the second supply pack positioned as described herein may be ruptured due to the increase in pressure caused by the expansion of the electrodes or the like inside the case 101. Accordingly, the first supplementary electrolyte e2 and/or the second supplementary electrolyte e3 may be supplied into the case 101. The first electrolyte e1 already filled inside the case 101 may react with the electrodes 10 and 20 through charging and discharging, and thus, the concentration thereof may decrease.

Accordingly, the first supplementary electrolyte e2 and/or the second supplementary electrolyte e3 provided through the first supply pack and/or the second supply pack may be mixed with the existing electrolyte e1 by concentration gradient. In this manner, the electrolyte inside the case 101 may be supplemented and the decreased concentration of the electrolyte may be restored to a certain level.

In a case where the internal pressure of the case 101 reaches the first pressure, the (1-1)^{th} supply pack 111-1 and the (1-2)^{th} supply pack 111-2 facing each other may be first ruptured or opened so that the first supplementary electrolyte e2 may be supplied from one side surface of each of the lead tabs 104 and 105. Then, in a case where the internal pressure of the case 101 continues to increase and reaches the second pressure, the (2-1)^{th} supply pack 112-1 and the (2-2)^{th} supply pack 112-2 facing each other may be ruptured or opened so that the second supplementary electrolyte e3 may be supplied from the other side surfaces of the lead tabs 104 and 105.

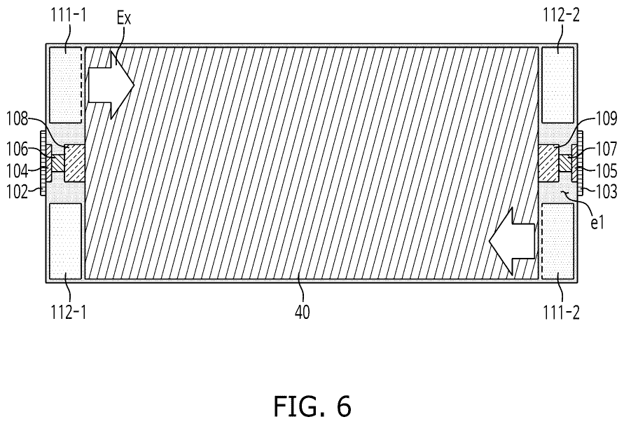

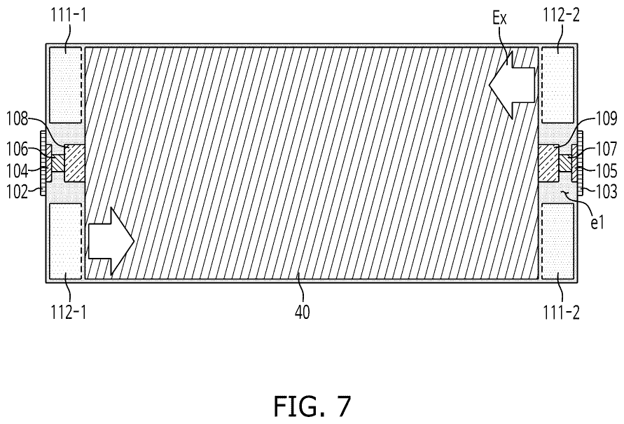

FIGS. 6 and 7 show that the first supply packs 111-1 and 111-2 positioned diagonally from each other inside the case 101 of the secondary battery 100 according to an embodiment of the present disclosure are pre-opened and the second supply packs 112-1 and 112-2 positioned diagonally from each other are post-opened. Referring to FIGS. 6 and 7, one first supply pack 111-1 among one or more first supply packs may be positioned on one side surface of the first lead tab 104 of the first electrode 10 in the internal space of the case 101, and one second supply pack 112-2 among one or more second supply packs may be positioned on the other side surface of the second lead tab 105 of the second electrode 30 in the internal space of the case 101. Similarly, another first supply pack 111-2 among one or more first supply packs may be positioned on one side surface of the second lead tab 105 of the second electrode 30 in the internal space of the case 101, and another second supply pack 112-1 among one or more second supply packs may be positioned on the other side surface of the first lead tab 104 of the first electrode 10 in the internal space of the case 101. That is, as shown, the (1-1)^{th} supply pack 111-1 and the (2-2)^{th} supply pack 112-2 may be positioned to face each other on one side surface of each of the lead tabs 104 and 105 with the electrode assembly 40 as the center, and the (1-2)^{th} supply pack 111-2 and the (2-1)^{th} supply pack 112-1 may be positioned to face each other on the other side surface of each of the lead tabs 104 and 105 with the electrode assembly 40 as the center.

In the present example, as the internal pressure of the case 101 reaches the first pressure, the (1-1)^{th} supply pack 111-1 and the (1-2)^{th} supply pack 111-2, which are positioned diagonally to face each other with the electrode assembly 40 as the center, may first discharge the first supplementary electrolyte e2. In some embodiments, as the internal pressure of the case 101 reaches the second pressure, the (2-1)^{th} supply pack 112-1 and the (2-2)^{th} supply pack 112-2, which are positioned diagonally to face each other with the electrode assembly 40 as the center, may discharge the second supplementary electrolyte e3.

As described herein, because the first supply pack and the second supply pack, which are configured to discharge the electrolyte in response to different pressures, are positioned diagonally to face each other with the electrode assembly as the center, the supplementary electrolyte supplied according to the increase in pressure inside the case may be effectively mixed with the existing electrolyte.

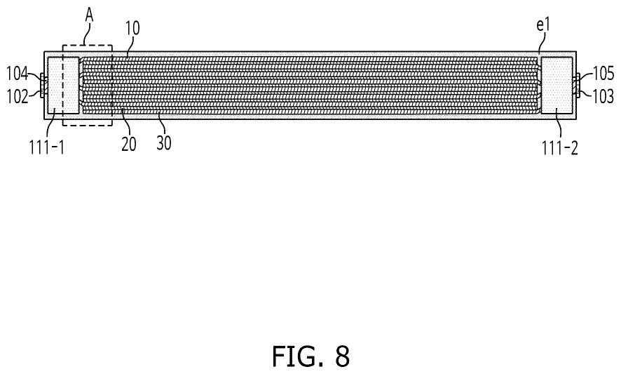

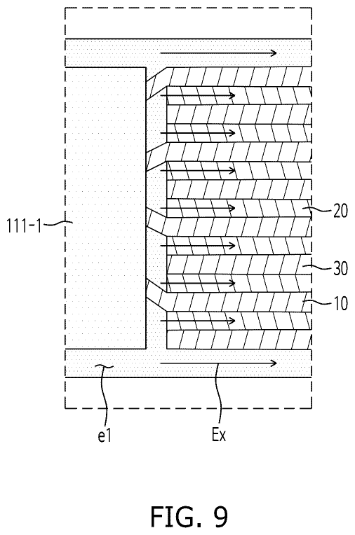

FIG. 8 illustrates a cross-sectional view of the secondary battery according to an embodiment of the present disclosure. FIG. 9 illustrates an enlarged area A of the periphery of the (1-1)^{th} supply pack 111-1 in the cross-sectional view of the secondary battery of FIG. 8. Referring to FIG. 8, in a case where the electrolyte supply packs 111-1 and 111-2 are opened due to the increase in the internal pressure of the case 101 in a state in which the electrodes 10 and 20 are expanded, the supplementary electrolyte may diffuse toward the center of the case 101.

As shown in FIG. 9, the (1-1)^{th} supply pack 111-1 may discharge the first supplementary electrolyte e2 in the direction Ex toward the electrode assembly 40 due to the increase in the internal pressure of the case 101. The discharge direction Ex may be a direction toward the center of the electrode assembly 40 of the case 101. Because the electrolyte supply pack is positioned in the space between the electrode assembly 40 and the inner side of the case 10 inside the case 101, i.e., on the edge side inside the case 10, the discharge direction Ex of the first supplementary electrolyte e2 may be directed toward the center of the case 101 so that the first supplementary electrolyte e2 may be effectively mixed with the existing electrolyte e1.

Accordingly, the first supplementary electrolyte e2 and the existing electrolyte e1 may be mixed according to not only the discharge pressure of the first supplementary electrolyte e2 discharged from the (1-1)^{th} supply pack 111-1 but also the concentration gradient of the existing electrolyte e1 and the first supplementary electrolyte e2, and may be diffused throughout the entire internal area of the case 101.

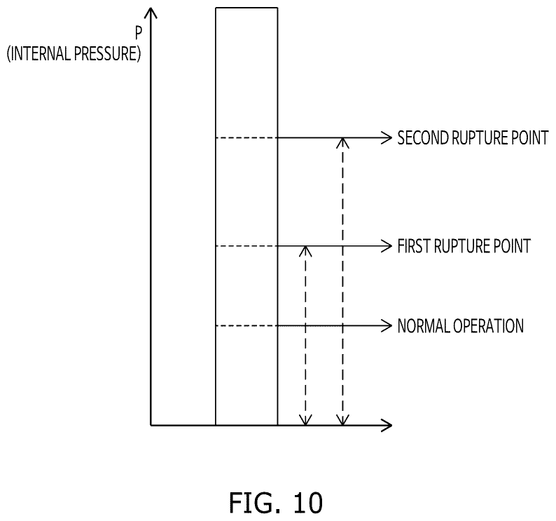

FIG. 10 illustrates a first rupture point at which a first supply pack is opened and a second rupture point at which a second supply pack is opened, according to an embodiment of the present disclosure. According to an embodiment, the first rupture point at which the first supply pack is opened and the second rupture point at which the second supply pack is opened may be set to be different from each other. For example, as shown in FIG. 10, the second pressure may be higher than the first pressure, and the first pressure may be higher than the pressure before the pressure increases due to expansion of the electrode or the like inside the case of the secondary battery (i.e., in a normal operating state).

Typically, the secondary battery case may have a vent formed therein so as to be ruptured or opened when the pressure increases due to an abnormal event (e.g., gas generation due to a reaction between the electrolyte and the electrode, thermal runaway, etc.). In this case, the first pressure and the second pressure may be set to be lower than the rupture or opening pressure of the vent provided in the case. For example, the first pressure may be ½ and the second pressure may be ⅔ with respect to the pressure at which the vent portion 101a formed in the case is opened. The electrolyte supply pack may be provided with a rupture portion so as to be ruptured or opened in response to the first pressure and the second pressure set as described herein. That is, the rupture portion provided in the first supply pack may be configured to be opened in response to the first pressure, and the rupture portion provided in the second supply pack may be configured to be opened in response to the second pressure.

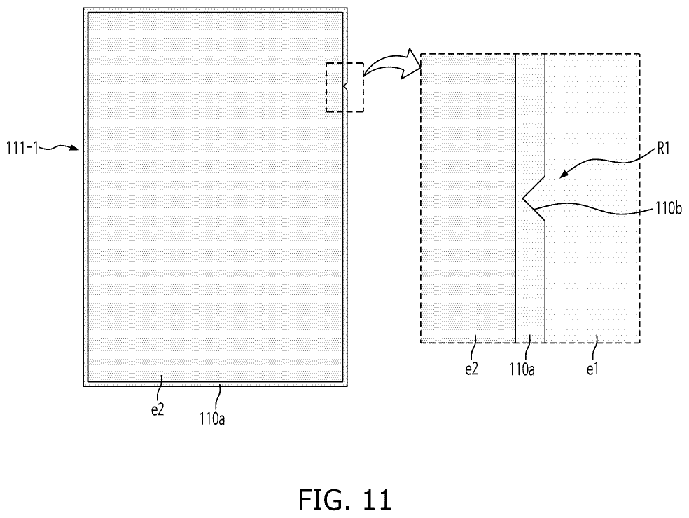

FIGS. 11 to 13 illustrate various shapes of rupture portions R according to an embodiment of the present disclosure. Referring to FIGS. 11 to 13, according to an embodiment of the present disclosure, the electrolyte supply pack 111-1 may include a thin film 110a and a first supplementary electrolyte e2 contained in the thin film 110a. The thin film 110a may include at least one of polyamide (PA), polyethylene (PE), or polypropylene (PP).

In some embodiments, the thin film 110a may include a rupture portion configured to be ruptured when the internal pressure of the case 101 in which the electrolyte supply pack 111-1 is installed reaches a predetermined pressure. The rupture portion may include one or more notches having a thickness less than a thickness of the periphery of the rupture portion on the thin film 110a. The notch of the rupture portion R may be formed on the thin film 110a in various shapes.

Referring to FIG. 11, a rupture portion R1 may include an outer rupture surface 110b formed on the outer surface of the thin film 110a. The outer rupture surface 110b may be configured in a shape recessed from the outer surface of the thin film 110a. In a case where the internal pressure of the case 101 increases due to the swelling phenomenon of the electrode, the rupture portion R1 formed with a relatively thin thickness on the outer surface of the thin film 110a may be ruptured and opened. The first supplementary electrolyte e2 contained in the thin film 110a may be discharged through the opened opening.

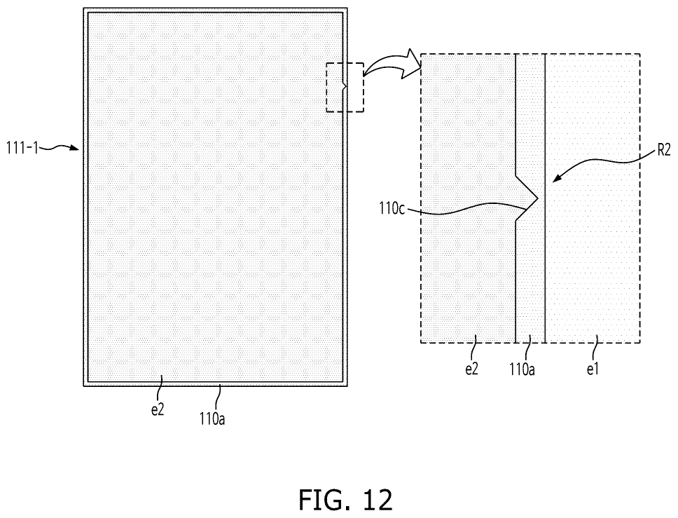

Referring to FIG. 12, a rupture portion R2 may include an inner rupture surface 110c formed on the inner surface of the thin film 110a. The inner rupture surface 110c may be configured in a shape recessed from the inner surface of the thin film 110a. In a case where the internal pressure of the case 101 increases due to the swelling phenomenon of the electrode, the rupture portion R2 formed with a relatively thin thickness on the inner surface of the thin film 110a may be ruptured and opened. The first supplementary electrolyte e2 contained in the thin film 110a may be discharged through the opened opening.

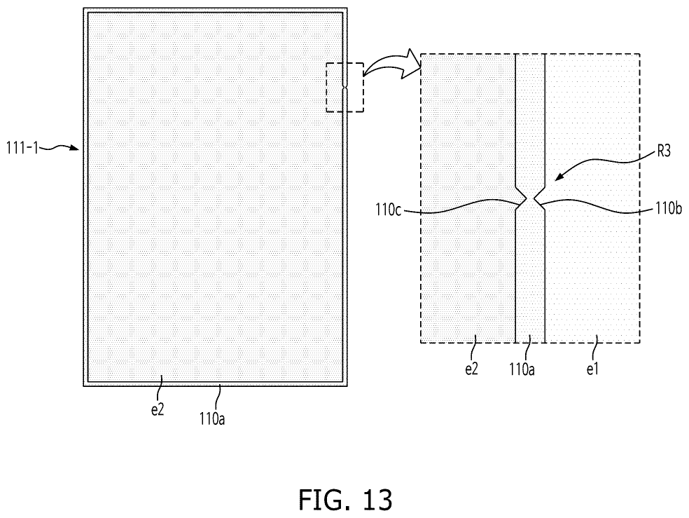

Referring to FIG. 13, a rupture portion R3 may include an inner rupture surface 110c formed on the inner surface of the thin film 110a and an outer rupture surface 110b formed on the outer surface of the thin film 110a. The outer rupture surface 110b and the inner rupture surface 110c may be configured in a shape recessed from the outer surface and the inner surface of the thin film 110a, respectively. In a case where the internal pressure of the case 101 increases due to the swelling phenomenon of the electrode, the rupture portion R3 formed with a relatively thin thickness on the outer surface and the inner surface of the thin film 110a may be ruptured and opened. The first supplementary electrolyte e2 contained in the thin film 110a may be discharged through the opened opening.

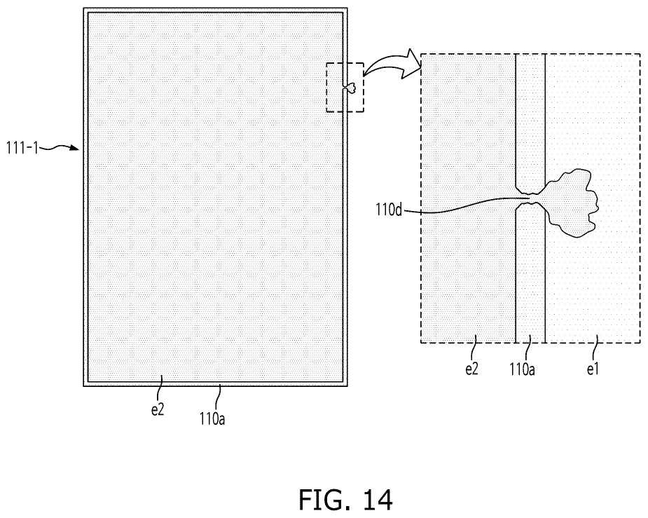

FIG. 14 illustrates the discharge form of the first supplementary electrolyte e2 according to an embodiment of the present disclosure. Referring to FIG. 14, a discharge port 110d may be formed on the thin film 110a by the rupture of the rupture portions R1, R2, and R3 of FIGS. 11 to 13 described herein. Accordingly, the first supplementary electrolyte e2 may be diffused into the area of the existing electrolyte e1 by the discharge pressure of the first supplementary electrolyte e2 contained in the thin film 110a and the concentration gradient of the first supplementary electrolyte e2 and the existing electrolyte e1. Accordingly, the concentration of the electrolyte inside the case 101 may be increased while the amount of the electrolyte may be increased.

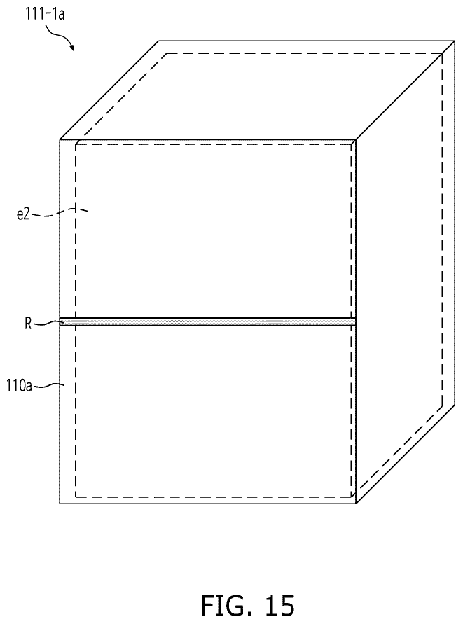

FIGS. 15 to 18 illustrate the first supplementary electrolyte e2 as an example of the electrolyte supply pack 110 according to an embodiment of the present disclosure.

Referring to FIG. 15, according to an embodiment, a rupture portion R formed in an electrolyte supply pack 111-1a may be formed on one side surface facing the electrode assembly on the thin film 110a in a case where the electrolyte supply pack 111-1a is positioned inside the case of the secondary battery. The rupture portion R may be provided in a direction facing the electrode assembly and may be formed in a shape extending in the width direction of one side surface of the thin film 110a. In this case, the rupture portion R is ruptured in the width direction of one side surface of the thin film 110a, so that the first supplementary electrolyte e2 may be discharged.

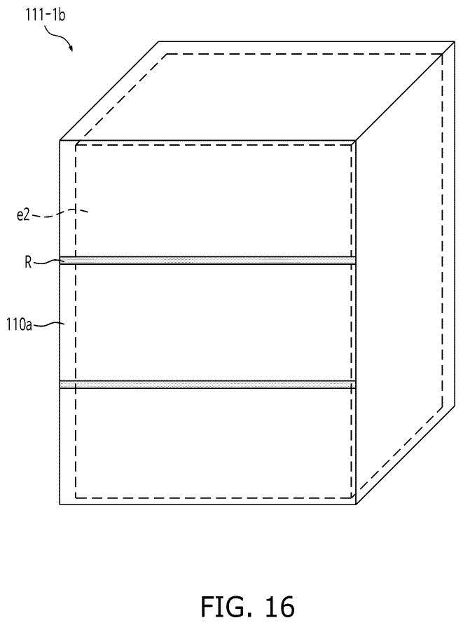

In another embodiment, referring to FIG. 16, a rupture portion R formed in an electrolyte supply pack 111-1b may be formed on one side surface of the thin film 110a facing the electrode assembly. In some embodiments, a plurality of rupture portions R may be provided on the side surface facing the electrode assembly on the thin film 110a and may be formed in a shape extending in the width direction of the side surface. In this case, the rupture portion R is ruptured in the width direction of one side surface of the thin film 110a, so that the first supplementary electrolyte e2 may be discharged. By forming a plurality of rupture portions R on the thin film 110a as described herein, the first supplementary electrolyte e2 discharged through the rupture portions R may be more effectively diffused to the long side surface or the short side surface of the electrode assembly.

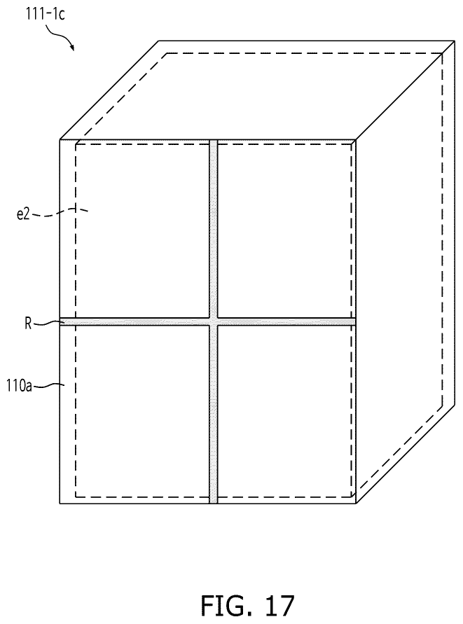

In another embodiment, referring to FIG. 17, a rupture portion R formed in an electrolyte supply pack 111-1c may be formed on one side surface facing the electrode assembly on the thin film 110a. In some embodiments, the rupture portion R may include a rupture portion of a straight line formed in a horizontal direction on the corresponding side surface and a rupture portion of a straight line formed in a vertical direction intersecting therewith. The two rupture portions R formed to intersect with each other may discharge the first supplementary electrolyte e2 in the width direction and the height direction of one side surface of the thin film 110a. In this manner, the first supplementary electrolyte e2 discharged through the rupture portion R may be more effectively diffused to the long side surface or the short side surface of the electrode assembly.

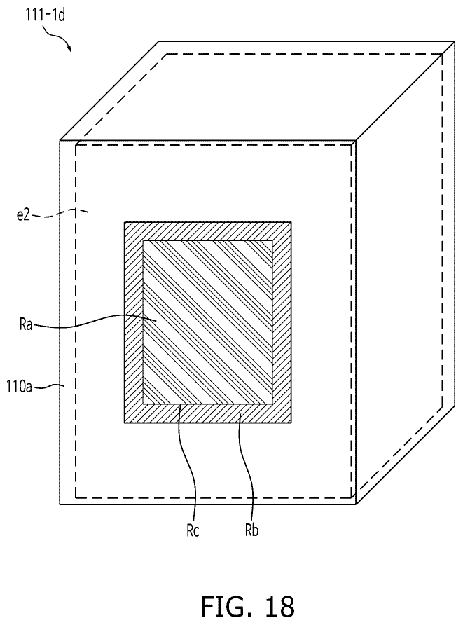

Referring to FIG. 18, the rupture portion R formed in the electrolyte supply pack 111-1d may include a thin film patch Ra bonded to the periphery of the opening or opened portion Rc formed on the thin film 110a. The thin film patch Ra may seal the opening Rc formed on one side surface of the thin film 110a. For example, in a state in which the thin film patch Ra is overlapped around the opening Rc of the thin film 110a containing the first supplementary electrolyte e2, the overlapping portion is sealed by using a laser, and thus, an adhesive portion Rb may be formed along the edge of the opening Rc. The adhesive strength of the adhesive portion Rb may be set to be ruptured in a case where the external pressure of the electrolyte supply pack 111-1d reaches the first pressure or the second pressure. That is, in a case where the external pressure of the electrolyte supply pack 111-1d reaches the first pressure or the second pressure, at least a portion of the adhesive portion Rb may be ruptured or opened so that the first supplementary electrolyte e2 may be discharged through the opened portion Rc.

Although the present disclosure has been described with reference to the limited embodiments and drawings, the present disclosure is not limited thereto, and various modifications and variations are possible by those of ordinary skill in the art within the scope of the technical idea of the present disclosure and the equivalent scope of the claims to be described herein.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

What is claimed is:

1. A secondary battery comprising:
an electrode assembly comprising a first electrode, a separator, and a second electrode;
a case configured to accommodate the electrode assembly; and
an electrolyte supply pack positioned in a space between the electrode assembly and an inner surface of the case and configured to supply a supplementary electrolyte into the case when an internal pressure of the case reaches a predetermined pressure.

2. The secondary battery as claimed in claim 1, wherein:
a first electrode terminal electrically connected to a first lead tab of the first electrode is formed on a first side surface of the case; and
the electrolyte supply pack is positioned adjacent to the first lead tab of the first electrode inside the case.

3. The secondary battery as claimed in claim 1, wherein the electrolyte supply pack comprises:
one or more first supply packs configured to supply a first supplementary electrolyte when the internal pressure of the case reaches a first pressure; and
one or more second supply packs configured to supply a second supplementary electrolyte when the internal pressure of the case reaches a second pressure that is different from the first pressure.

4. The secondary battery as claimed in claim 3, wherein the first pressure is ½ and the second pressure is ⅔ with respect to a pressure at which a vent portion formed in the case is opened.

5. The secondary battery as claimed in claim 3, wherein:
a first electrode terminal electrically connected to a first lead tab of the first electrode is formed on a first side surface of the case; and
one first supply pack among the one or more first supply packs is positioned on one side surface of the first lead tab of the first electrode in an internal space of the case, and one second supply pack among the one or more second supply packs is positioned on another side surface of the first lead tab of the first electrode in the internal space of the case.

6. The secondary battery as claimed in claim 5, wherein:
a second electrode terminal electrically connected to a second lead tab of the second electrode is formed on a second side surface opposite to the first side surface of the case; and
another first supply pack among the one or more first supply packs is positioned on one side surface of the second lead tab of the second electrode in the internal space of the case, and another second supply pack among the one or more second supply packs is positioned on another side surface of the second lead tab of the second electrode in the internal space of the case.

7. The secondary battery as claimed in claim 3, wherein the one or more first supply packs and the one or more second supply packs are positioned to face each other inside the case.

8. The secondary battery as claimed in claim 1, wherein the electrolyte supply pack comprises a thin film that contains the supplementary electrolyte.

9. The secondary battery as claimed in claim 8, wherein the thin film comprises at least one of polyamide (PA), polyethylene (PE), or polypropylene (PP).

10. The secondary battery as claimed in claim 8, wherein the thin film comprises a rupture portion configured to be ruptured when the internal pressure of the case reaches the predetermined pressure.

11. The secondary battery as claimed in claim 10, wherein the rupture portion is positioned at a location facing the electrode assembly on the thin film.

12. The secondary battery as claimed in claim 10, wherein the rupture portion comprises one or more notches having a thickness less than a thickness of a periphery of the rupture portion on the thin film.

13. The secondary battery as claimed in claim 10, wherein the rupture portion comprises a thin film patch bonded to a periphery of a vent formed on the thin film.

14. A secondary battery comprising:
an electrode assembly comprising a first electrode, a separator, and a second electrode;
a case configured to accommodate the electrode assembly, wherein the first electrode is formed on a first side surface and electrically connected to a first lead tab of the first electrode, and the second electrode is formed on a second side surface opposite the first side surface and electrically connected to a second lead tab of the second electrode; and
an electrolyte supply pack positioned on at least one side surface of the first lead tab of the first electrode or the second lead tab of the second electrode in a space between the electrode assembly and an inner surface of the case, and configured to supply a supplementary electrolyte into the case when internal pressure of the case reaches a predetermined pressure.

15. The secondary battery as claimed in claim 14, wherein the electrolyte supply pack comprises a thin film that contains the supplementary electrolyte.

16. The secondary battery as claimed in claim 14, wherein the electrolyte supply pack comprises:
one or more first supply packs configured to supply a first supplementary electrolyte when the internal pressure of the case reaches a first pressure; and
one or more second supply packs configured to supply a second supplementary electrolyte when the internal pressure of the case reaches a second pressure that is different from the first pressure.

17. The secondary battery as claimed in claim 16, wherein the second pressure is 1.5 to 2 times the first pressure.

18. The secondary battery as claimed in claim 16, wherein one first supply pack among the one or more first supply packs is positioned on one side surface of the first lead tab of the first electrode in an internal space of the case, and one second supply pack among the one or more second supply packs is positioned on another side surface of the first lead tab of the first electrode in the internal space of the case.

19. The secondary battery as claimed in claim 18, wherein another first supply pack among the one or more first supply packs is positioned on one side surface of the second lead tab of the second electrode in an internal space of the case, and another second supply pack among the one or more second supply packs is positioned on another side surface of the second lead tab of the second electrode in the internal space of the case.

20. The secondary battery as claimed in claim 16, wherein the one or more first supply packs and the one or more second supply packs are positioned to face each other inside the case.
